(19) United States
(12) Patent Application Publication
(10) Pub. No.: US 2026/0136167 A1
(43) Pub. Date: May 14, 2026

(54) EMERGENCY CONNECTION SERVICES

(71) Applicant: Intrado Life & Safety, Inc., Longmont, CO (US)

(72) Inventor: Robert E. Leetun, Longmont, CO (US)

(21) Appl. No.: 18/947,703

(22) Filed: Nov. 14, 2024

(51) Int. Cl. H04W 4/90; H04W 4/14; H04W 64/00

(52) U.S. Cl. CPC H04W 4/90; H04W 4/14; H04W 64/00

(57) ABSTRACT

A computer-implemented system and method of providing location-based emergency connection services includes receiving an emergency call from a remote device, the remote device having a one-click emergency call interface; receiving a global positioning system (GPS) location for the remote device; correlating the GPS location with global information system (GIS) data for the GPS location; alerting a public safety answering point (PSAP), including providing the GPS location and GIS data; and dispatching an emergency responder to the GPS location based on the GIS data.

### FIELD OF THE SPECIFICATION

This application relates in general to public safety, and more particularly though not exclusively to a system and method for providing emergency connection services.

### BACKGROUND

In the United States, the well-known number “911” is used as a uniform number to contact emergency services. In other countries, different numbers such as “999” are used. Furthermore, the United States has recently rolled out a “988” suicide prevention hotline, which is similar to 911, but provides emergency suicide prevention counseling instead of other emergency services.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of a emergency services ecosystem.

FIG. 2 is a block diagram of selected elements of wireless communication ecosystem.

FIG. 3 is a block diagram of selected elements of a host smart device.

FIG. 4 is a block diagram of selected elements of a golf cart computing system.

FIG. 5 is a block diagram of selected elements of a communication ecosystem.

FIG. 6 is an illustration of selected elements of a graphical user interface (GUI).

FIG. 7 is an illustration of selected elements of GUI.

FIG. 8 is an illustration of selected elements of GUI.

FIG. 9 is an illustration of selected elements of GUI.

FIG. 10 is an illustration of selected elements of GUI.

FIG. 11 is an illustration of selected elements of GUI.

FIG. 12 is an illustration of selected elements of GUI.

FIG. 13 is an illustration of selected elements of GUI.

FIG. 14 is a block diagram of selected elements of an emergency data broker.

FIG. 15 is a flow chart of selected elements of a method of providing emergency data.

FIG. 16 is a block diagram of selected elements of a hardware platform.

FIG. 17 is a block diagram of selected elements of a network function virtualization (NFV) infrastructure.

FIG. 18 is a block diagram of selected elements of a containerization infrastructure.

### SUMMARY

A computer-implemented system and method of providing location-based emergency connection services includes receiving an emergency call from a remote device, the remote device having a one-click emergency call interface; receiving a global positioning system (GPS) location for the remote device; correlating the GPS location with global information system (GIS) data for the GPS location; alerting a public safety answering point (PSAP), including providing the GPS location and GIS data; and dispatching an emergency responder to the GPS location based on the GIS data.

### Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

911 and similar emergency services are considered critical infrastructure for developed countries. Key issues for a 911 call include determining what the emergency is and where the emergency is. In legacy 911 infrastructure, a landline is associated with a specific physical location. For example, the fictional phone number (111)555-6789 may be physically connected to the fictional address 123 Elm St., Anytown, USA. Thus, if a 911 call originates from the given phone number, the legacy 911 system includes infrastructure to correlate the phone number with the location and route the call to an appropriate PSAP based on this association, and a 911 operator's console may display the associated address on a 911 operator's console. Even with this addresses displayed, the 911 operator may generally be trained to ask, “Where is your emergency?” This gives the caller an opportunity to clarify or provide additional information.

In more contemporary practice, fewer and fewer people have landlines, especially as their primary or sole telephone number. Even in developing countries, cellular communication devices using, e.g., 2G, 3G, 4G, 5G, 6G, or other communication protocols have become the most common telephone service. Emergency services infrastructure has therefore evolved to include location services that can be used to identify the location of a mobile device that contacts emergency services. For example, a location services function may triangulate a location based on signal strength to two or more cell phone towers, with accuracy improving with each generation. Again, the operator may still ask where the emergency is, to supplement the caller's inferred location. The resolution of the location services may depend in part on the technology being used. Earlier-generation cellular services could triangulate an approximate location with around a kilometer of resolution. As technology has improved, and as most mobile devices now have GPS receivers, location accuracy has also improved such that current technology can locate a caller to within a sub-meter resolution.

There are, however, still gaps in emergency services and responses. Identifying the caller's location is not merely a procedural query, but is a substantive matter for dispatching emergency responders to handle the emergency at the right location. Challenges can arise when callers are unable to provide precise location details, especially in situations where physical addresses may not be present, such as on a golf course or within a so-called “golf cart community.” In such scenarios, time spent determining the caller's location may impact the quality of the response, because seconds matter in emergency situations. This can jeopardize life or safety, and can have a serious impact on the effectiveness of emergency responses.

Emergency services may be just as necessary in environments where traditional addressing systems are inadequate as they are in environments where well-defined addresses are available. Emergencies may occur in settings such as workplaces, schools, high-rise buildings, golf courses, golf cart communities, college campuses, medical centers, other large campuses, recreational areas, or similar, where pinpointing the exact location can itself become a difficult task. For example, a call originating from a large golf course may pose significant hurdles in determining the caller's whereabouts. In such scenarios, relying solely on verbal descriptions from callers may lead to delays and inefficiencies in dispatching emergency services. Furthermore, not every person can be expected to carry a modern 4G or 5G cell phone at all times. Some people are uncomfortable or unfamiliar with the technology, others may simply forget their phones, and yet others may deliberately leave their mobile devices behind while recreating to unplug from the distractions of the online world.

The present specification provides systems and methods for linking a PSAP to a linked community GPS. This linkage can provide additional options and devices that individuals can use to connect with 911 for public safety services. Automatic transmission of location information from these devices to 911 call centers or other PSAPs can expedite emergency responses. Seamless integration between the 911 call and accurate GPS location enhances the efficiency of emergency services and empowers consumers with an assurance that help can reach them quickly and accurately.

In one illustrative use case, the present specification illustrates a golf cart or other small electric vehicle that is equipped with a built-in emergency alert function. The term “golf cart,” as used here, is not intended to be limited to vehicles used for golfing. Rather, “golf cart” applies to a class of small utility vehicles, usually smaller than an ordinary passenger vehicle, and not designed for or legal to operate on public roadways. These may include golf-carts, go-carts, rail carts, and others. The teachings of the present specification may also apply to other non-street-legal vehicles, such as all-terrain vehicles (ATVs), snowmobiles, side-by-sides, tractors, or similar.

The emergency alert function may include a physical button, such as a prominent red or other colored button that a user can press to instantly “dial” 911. Other “one-click” solutions may also be used, such as a prominent software button on a home screen or in another easily-accessible location. Such a button is advantageous because in a high-stress emergency situation, users who are unfamiliar or uncomfortable with cell phones may struggle to place the call correctly. Furthermore, experientially, many users will accidentally dial 912 or otherwise misdial a number in a high-stress situation. The availability of a simple one-click interface for reaching 911 may thus be lifesaving in some situations. In the illustrative use case, the golf cart is equipped with a GPS receiver and associated infrastructure, so that it can, along with the 911 call, seamlessly send accurate GPS location data for the user. In another example, instead of a physical button, the golf cart may be provided with a touchscreen user device that provides useful applications such as local course or community information, apps, games, maps, and other useful data. Advantageously, this touchscreen device may be available on a “smart” golf cart, even if the user does not own a cell phone or chooses not to bring a cell phone. In this case, the app user interface (UI) may include icons for a number of useful applications, and may also include a prominent emergency alert button that is also a one-click interface to place a 911 call. In one embodiment, the 911 emergency call button is always visible on the screen, so that the user does not have to search through menus or go back and forth between applications trying to find the button.

Such a golf cart may be used on a golf course, or within a so-called golf cart community. In some planned communities, traditional vehicle traffic is prohibited, and users navigate the community on individually owned or community-shared golf carts or other similar small electric vehicles. It is common for these to have a smart interface, with local information, maps, and other features. A user traversing the community in such a cart may not know his or her exact location, and not every location will have a traditional address. In the case of an emergency, a person can use the one-click interface to call 911 and provide an immediate and accurate GPS location to the PSAP so that dispatchers can immediately send emergency responders.

Similar GPS-aided easy-access emergency buttons may also be provided in other contexts. In general, a vehicle or static structure may be outfitted with a GPS receiver, and a one-click emergency button may connect the caller to a PSAP via an emergency data broker, which may be a network function that receives the alert from a device, along with GPS data, correlates the GPS location to geographical information system (GIS) data, and packages the data for forwarding to a traditional PSAP. In one example, the GPS location may include an exact (X, Y, Z) location. The (X, Y, Z) protocol may be important because vertical displacement may also matter. For example, in a high-rise office building, it may not be sufficient to know the ground coordinates of the building; first responders may also need to know which floor a call originated from. Emergency call boxes or kiosks may be installed for example in classrooms, campuses (college, medical, business), large parks (e.g. Central Park in New York), small parks, tall buildings, national parks or forests, public trails, ranger stations, basements, parking garages, utility or recreational vehicles, all-terrain vehicles, side-by-side vehicles, snowmobiles, active elder or retired senior centers, or other vehicles or static structures. In some cases, it may also be valuable to provide real-time updates to emergency responders, such as in cases where location may change. For example, emergency buttons could be installed in buses, trains, public transport, ships, ocean liners, fishing boats, or other. In yet another example, devices could be installed in restrooms or washrooms for safety purposes (e.g., in restaurants or bars), such as for a woman on a blind date who feels unsafe and also does not feel safe speaking up in the presence of her date.

In another illustrative use case, GPS-enhanced single-click devices may be used to aid in combat operations. For example, a military radio, vehicle, or other equipment may be provisioned with a one-click emergency button that can place a commander in contact with a headquarters or other post. The one-click button may automatically connect to the headquarters or outpost (which in this example provides the function of a PSAP), and open a verbal communication line while also providing real-time GPS coordinate updates for the deployed unit. In that case, the commander can request exfiltration, air support, or other emergency services that can enhance survivability in a combat situation.

In yet another example, firefighters may be provided with a one-click emergency button or interface that they can use to contact a base in the case of danger or encirclement. This would provide real-time GPS location for the firefighter, along with a verbal link to request assistance.

The verbal link may provide a valuable cooperative enhancement to the GPS location. For example, in the case of a golf cart, a microphone and speaker may be provisioned along with the 911 button so that the caller can speak with the 911 dispatcher. In other cases, capable audio and/or video interfaces may already exist, and the emergency button may provide an autodialer or an auto frequency selector to place the caller in communication with the appropriate PSAP or equivalent. For example, in the case of a dedicated kiosk, the speaker and microphone and/or video conferencing equipment may be built into the device. In another example, the dedicated device may cooperate with an earlier generation cell phone such as 2G, 3G, or similar, where high-resolution location data may not be available. In that case, even where users have earlier generation devices, or where later generation coverage is not available, a 911 call can be enhanced with accurate GPS location services. In the case of a military unit, a radio man may already carry a capable radio for communicating with the base. This can be enhanced with an emergency call button that will immediately provide GPS coordinates, and select the appropriate frequency, encryption, and/or protocols to communicate with the base for the emergency. In the case of a boat or ship at sea, the autodialer may select an appropriate emergency frequency for radio equipment, or may autodial a satellite phone.

The system and method of the present specification realizes advantages over existing systems. For example, individuals who use the system and method may use any available device to connect with 911 operators. For example, a human user may have a wearable computing device or a wearable alert button that connects to a wired or wireless communication device and includes GPS capabilities. When a 911 call is placed, the GPS data may be provided directly to the PSAP and linkages may establish connections between geographic areas and corresponding PSAPs. This provides for rapid identification and routing of emergency calls to the appropriate authorities and first responders. Advantageously, whether the caller utilizes a smartphone, a hardware button, an IoT device, a wearable, or other connected gadget, the PSAP link may integrate seamlessly with diverse communication platforms. Furthermore, the system may be scalable and adaptable. This may include seamless integration with existing 911 infrastructure, which can facilitate widespread adoption and scalability.

Furthermore, the present architecture may equip both the caller and the first responder with better information. For example, in addition to automatically sending (X, Y, Z) coordinates for the caller, an app may visually provide the caller with a plain text description of his or her current location. For example, if an emergency occurs on hole nine of the blue course of a multicourse golf club, the caller may not immediately remember which course he or she is on, or in the high-stress environment of an emergency, the caller may mistakenly believe that he or she is on the green course. This plain text description will help the caller better articulate the location when calling for emergency services. Furthermore, in military, law enforcement, firefighting, or other applications, the operator of the equipment may have migrated and may think that he is in a different location than he actually is. For example, the caller may believe that he is currently in sector Delta of a grid location, when in fact, without realizing it, he and his team have moved to sector echo. In that case, confusion can be avoided by displaying to the operator that he is currently in sector echo when he calls for assistance such as extraction, exfiltration, artillery support, air support, or other.

### Selected Examples

The foregoing can be used to build or embody several example implementations, according to the teachings of the present specification. Some example implementations are included here as nonlimiting illustrations of these teachings.

Example 1 includes a computer-implemented method of providing location-based emergency connection services, comprising: receiving an emergency call from a remote device, the remote device having a one-click emergency call interface; receiving a global positioning system (GPS) location for the remote device; correlating the GPS location with global information system (GIS) data for the GPS location; alerting a public safety answering point (PSAP), including providing the GPS location and GIS data; and dispatching an emergency responder to the GPS location based on the GIS data.

Example 2 includes the method of example 1, wherein the remote device is a wearable fob.

Example 3 includes the method of example 1, wherein the remote device is a golf cart.

Example 4 includes the method of example 1, wherein the remote device is a non-street-legal vehicle.

Example 5 includes the method of example 1, wherein the remote device is a kiosk.

Example 6 includes the method of example 1, wherein the remote device is a ranger station or call box.

Example 7 includes the method of example 1, wherein the remote device is a call button in a restroom or other single-sex space for women associated with a restaurant or bar.

Example 8 includes the method of example 1, wherein the remote device is a military radio.

Example 9 includes the method of example 1, wherein the GPS location is a three-dimensional location.

Example 10 includes the method of example 1, wherein the GIS data comprise three-dimensional location information for a multi-story building.

Example 11 includes the method of example 1, wherein the GIS data comprise local map data for a walkable or golf-cart community.

Example 12 includes the method of example 1, wherein GIS data comprise local intelligence for a golf course or recreational location.

Example 13 includes the method of example 1, wherein GIS data comprise local intelligence for a trail or outdoor recreational location.

Example 14 includes the method of example 1, wherein the remote device moves, and further comprising providing real-time location to the PSAP and/or the emergency responder.

Example 15 includes the method of Example 1, wherein emergency call comprises a text message.

Example 16 includes the method of example 15, further comprising operating an artificial intelligence engine to provide a digest of the text message.

Example 17 includes the method of example 1, further comprising placing an operator of the remote device in verbal contact with the PSAP.

Example 18 includes the method of example 1, further comprising placing an operator of the remote device in verbal contact with the emergency responder.

Example 19 includes the method of example 1, further comprising providing back to an operator of the remote device a plain-text description of the GPS location.

Example 20 includes the method of example 1, wherein the remote device includes an autodialer to interface with a telephone or radio.

Example 21 includes the method of example 20, wherein the telephone or radio includes a 2G or 3G device that lacks native GPS capability.

Example 22 includes the apparatus comprising means for performing the method of any of examples 1-21.

Example 23 includes the apparatus of example 22, wherein the means for performing the method comprise a processor and a memory.

Example 24 includes the apparatus of example 23, wherein the memory comprises machine-readable instructions that, when executed, cause the apparatus to perform the method of any of examples 1-21.

Example 25 includes the apparatus of any of examples 22-24, wherein the apparatus is a computing system.

Example 26 includes at least one computer readable medium comprising instructions that, when executed, implement a method or realize an apparatus as in any of examples 1-25.

Example 27 includes one or more tangible, nontransitory computer-readable storage media having stored thereon executable instructions to: receive, via a network interface, an emergency call from a remote device, the remote device having a one-click emergency call interface; receive, via the network interface, a global positioning system (GPS) location for the remote device; correlate the GPS location with global information system (GIS) data for the GPS location; and send a message to notify an emergency responder of the emergency call, including the GPS location and the GIS data.

Example 28 includes the one or more tangible, nontransitory computer-readable storage media of example 27, wherein the remote device is a wearable fob.

Example 29 includes the one or more tangible, nontransitory computer-readable storage media of example 27, wherein the remote device is a golf cart.

Example 30 includes the one or more tangible, nontransitory computer-readable storage media of example 27, wherein the remote device is a non-street-legal vehicle.

Example 31 includes the one or more tangible, nontransitory computer-readable storage media of example 27, wherein the remote device is a kiosk.

Example 32 includes the one or more tangible, nontransitory computer-readable storage media of example 27, wherein the remote device is a ranger station or call box.

Example 33 includes the one or more tangible, nontransitory computer-readable storage media of example 27, wherein the remote device is a call button in a restroom or other single-sex space for women associated with a restaurant or bar.

Example 34 includes the one or more tangible, nontransitory computer-readable storage media of example 27, wherein the remote device is a military radio.

Example 35 includes the one or more tangible, nontransitory computer-readable storage media of example 27, wherein the GPS location is a three-dimensional location.

Example 36 includes the one or more tangible, nontransitory computer-readable storage media of example 27, wherein the GIS data comprise three-dimensional location information for a multi-story building.

Example 37 includes the one or more tangible, nontransitory computer-readable storage media of example 27, wherein the GIS data comprise local map data for a walkable or golf-cart community.

Example 38 includes the one or more tangible, nontransitory computer-readable storage media of example 27, wherein GIS data comprise local intelligence for a golf course or recreational location.

Example 39 includes the one or more tangible, nontransitory computer-readable storage media of example 27, wherein GIS data comprise local intelligence for a trail or outdoor recreational location.

Example 40 includes the one or more tangible, nontransitory computer-readable storage media of example 27, wherein the remote device moves, and wherein the instructions are further to provide real-time location to emergency responder.

Example 41 includes the one or more tangible, nontransitory computer-readable storage media of example 27, wherein emergency call comprises a text message.

Example 42 includes the one or more tangible, nontransitory computer-readable storage media of example 41, wherein the instructions are further to operate an artificial intelligence engine to provide a digest of the text message.

Example 43 includes the one or more tangible, nontransitory computer-readable storage media of example 27, wherein the instructions are further to place an operator of the remote device in verbal contact with the emergency responder.

Example 44 includes the one or more tangible, nontransitory computer-readable storage media of example 27, wherein the instructions are further to provide back to an operator of the remote device a plain-text description of the GPS location.

Example 45 includes the one or more tangible, nontransitory computer-readable storage media of example 27, wherein the remote device includes an autodialer to interface with a telephone or radio.

Example 46 includes the one or more tangible, nontransitory computer-readable storage media of example 45, wherein the telephone or radio includes a 2G or 3G device that lacks native GPS capability.

Example 47 includes a computing apparatus, comprising: a hardware platform comprising a processor circuit and a memory; a first network interface to communicatively couple to a remote device; a second network interface to communicatively couple to an emergency response service; and instructions encoded within the memory to instruct the processor circuit to: receive, via the first network interface, an emergency call from the remote device; receive, via the first network interface, a global positioning system (GPS) location for the remote device; correlate the GPS location with global information system (GIS) data for the GPS location; and send, via the second network interface, a message to notify the emergency response service of the emergency call, including the GPS location and the GIS data.

Example 48 includes the computing apparatus of example 47, wherein the GPS location is a three-dimensional location.

Example 49 includes the computing apparatus of example 47, wherein the GIS data comprise three-dimensional location information for a multi-story building.

Example 50 includes the computing apparatus of example 47, wherein the GIS data comprise local map data for a walkable or golf-cart community.

Example 51 includes the computing apparatus of example 47, wherein GIS data comprise local intelligence for a golf course or recreational location.

Example 52 includes the computing apparatus of example 47, wherein GIS data comprise local intelligence for a trail or outdoor recreational location.

Example 53 includes the computing apparatus of example 47, wherein the remote device moves, and wherein the instructions are further to provide real-time location to the emergency response service.

Example 54 includes the computing apparatus of example 47, wherein emergency call comprises a text message.

Example 55 includes the computing apparatus of example 54, wherein the instructions are further to operate an artificial intelligence engine to provide a digest of the text message.

Example 56 includes the computing apparatus of example 47, wherein the instructions are further to place an operator of the remote device in verbal contact with the emergency response service.

Example 57 includes the computing apparatus of example 47, wherein the instructions are further to provide back to an operator of the remote device a plain-text description of the GPS location.

Example 58 includes the computing apparatus of example 47, wherein the remote device includes an autodialer to interface with a telephone or radio.

Example 59 includes the computing apparatus of example 58, wherein the telephone or radio includes a 2G or 3G device that lacks native GPS capability.

Example 60 includes the computing apparatus of any of examples 47-59, wherein the remote device is a wearable fob.

Example 61 includes the computing apparatus of any of examples 47-59, wherein the remote device is a golf cart.

Example 62 includes the computing apparatus of any of examples 47-59, wherein the remote device is a non-street-legal vehicle.

Example 63 includes the computing apparatus of any of examples 47-59, wherein the remote device is a kiosk.

Example 64 includes the computing apparatus of any of examples 47-59, wherein the remote device is a ranger station or call box.

Example 65 includes the computing apparatus of any of examples 47-59, wherein the remote device is a call button in a restroom or other single-sex space for women associated with a restaurant or bar.

Example 66 includes the computing apparatus of any of examples 47-59, wherein the remote device is a military radio.

Example 67 includes the computing apparatus of any of examples 47-59, wherein the computing apparatus is a desktop computer.

Example 68 includes the computing apparatus of any of examples 47-59, wherein the computing apparatus is a workstation.

Example 69 includes the computing apparatus of any of examples 47-59, wherein the computing apparatus is a laptop computer.

Example 70 includes the computing apparatus of any of examples 47-59, wherein the computing apparatus is a notebook computer.

Example 71 includes the computing apparatus of any of examples 47-59, wherein the computing apparatus is a netbook.

Example 72 includes the computing apparatus of any of examples 47-59, wherein the computing apparatus is a tablet computer.

Example 73 includes the computing apparatus of any of examples 47-59, wherein the computing apparatus is a convertible tablet computer.

Example 74 includes the computing apparatus of any of examples 47-59, wherein the computing apparatus is a smart phone.

Example 75 includes the computing apparatus of any of examples 47-59, wherein the computing apparatus is an Android phone.

Example 76 includes the computing apparatus of any of examples 47-59, wherein the computing apparatus is an iPhone.

Example 77 includes the computing apparatus of any of examples 47-59, wherein the computing apparatus is a Windows phone.

Example 78 includes the computing apparatus of any of examples 47-59, wherein the computing apparatus is a server.

Example 79 includes the computing apparatus of example 78, further comprising a guest infrastructure to realize server functions.

Example 80 includes the computing apparatus of example 79, wherein the guest infrastructure comprises virtualization.

Example 81 includes the computing apparatus of example 79, wherein the guest infrastructure comprises containerization.

Example 82 includes the computing apparatus of any of examples 47-59, wherein the computing apparatus is realized as a telecommunication infrastructure service.

### DETAILED DESCRIPTION OF THE DRAWINGS

A system and method for emergency connection services will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

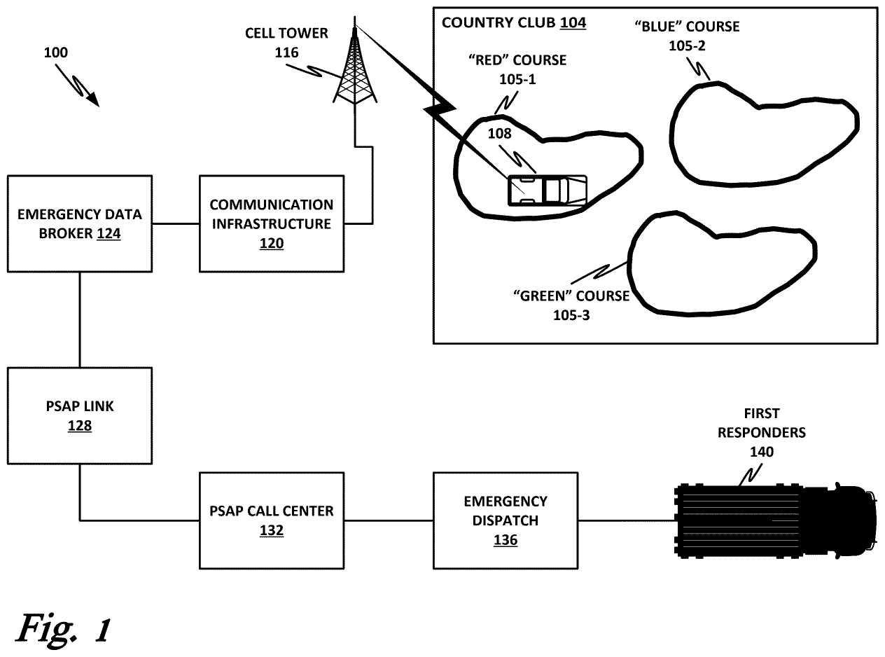

FIG. 1 is a block diagram illustration of an emergency response ecosystem 100. Within ecosystem 100, an illustration is provided of a country club 104. Country club 104 includes three separate courses, namely red course 105-1, blue course 105-2, and green course 105-3. A human user operates a golf cart 108, which in this case includes an emergency call button, which may be a hardware button on the golf cart (e.g., covered by a cage or other covered to prevent accidental pressing), or maybe a prominent button on a smart interface on golf cart 108. In this example, golfers Jane and Michael are golfing on red course 105-1. During their golf experience, Michael appears to have a medical emergency. It is advantageous to provide Jane with the single-click emergency button so that she can quickly call for assistance. In the stress of the situation, Jane could misdial 911 (e.g., by dialing 912), or she may be a user who does not frequently use a cell phone and is uncomfortable using it in an emergency. In yet other cases, Jane may have deliberately or inadvertently left her cell phone at the clubhouse, so as to enjoy her golfing experience without interruption.

Depending on the embodiment, when Jane operates the one-click emergency button, the device either connects via a wireless interface built into the golf cart 108, or connects to Jane's cell phone to contact cell tower 116.

Cell tower 116 operates with communication infrastructure 120, which may be for example 5G, 4G LTE, 3G, or other communication infrastructure. Infrastructure 120 may include location services that can interoperate with the GPS data from golf court golf cart 108. For example, the GPS data may be sent in parallel with the voice call via a data plane so that the GPS data are provided along with the voice call.

Communication infrastructure 120 routes the call through an emergency data broker 124, which may include infrastructure for correlating the GPS location of golf cart 108 with an appropriate PSAP. Emergency data broker 124 may then operate PSAP link 128 to connect Jane with a PSAP call center 132. Within a few seconds of this connection being made, an operator at PSAP call center 132 may speak with Jane, and may also see on his dispatch screen Jane's precise geographic location. Furthermore, Jane may see on her smart interface a plaintext and human-readable description such as she is that hole nine of red course 105-1. Thus, when the 911 operator speaks with Jane, he may ask her where is your emergency?” In the stress of the situation, Jane may not remember which course or which hole she is at, but the screen may display to her that she is a hole nine of the red course. Thus, she may respond to the 911 operator, “I am at hole nine of the red course of the country club.” The 911 operator may then further discuss with Jane the nature of the emergency, and may contact emergency dispatch 136 to dispatch first responders 140. First responders 140 can then proceed directly to hole nine of red course 105-1 and tend to Michael to address the emergency situation. The results may be less satisfactory if Jane panics and forgets exactly where she's at. For example, she may have played on the blue course yesterday, and thus may inadvertently say that she's at hole seven of the blue course, since she just played through hole seven. If first responders 140 then respond to hole seven of blue course 105-2, they will not find Michael there, and will have to spend time finding him and correcting his location before they can tend to him.

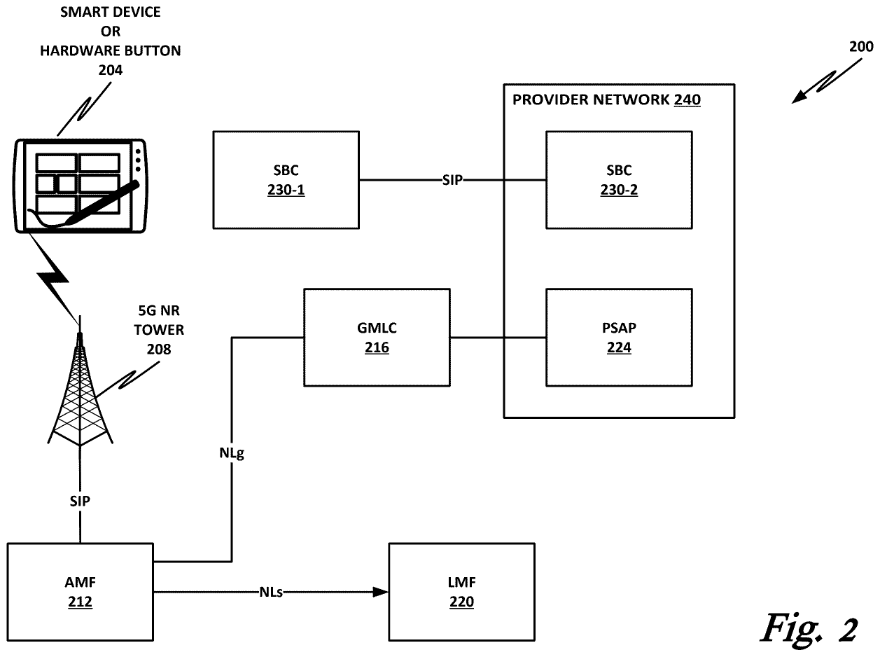

FIG. 2 is a block diagram of selected elements of an emergency response ecosystem 200, which may form a part of ecosystem 100 of FIG. 1, or which may be a separate ecosystem.

In this example, a smart device or hardware button 204 is provided with an emergency call function, such as a one-click emergency call function. When a user operates smart device or hardware button 204, the device may communicate with a cellular network such as a 5G (fifth generation) new radio (NR) tower 208. 5G NR tower 208 may then use session initiation protocol (SIP) to communicate with an access and mobility management function 212. AMF 212 receives connection and session information about the user equipment (UE), which in this case is smart device or hardware button 204.

AMF 212 may also use NLS to contact a location management function (LMF) 220. LMF 220 may use information such as 5G location data to provide a location for smart device or hardware button 204. GMLC 216 may use information such as information provided by LMF 220 or GPS information to locate the UE, and then route the call to an appropriate PSAP 224. PSAP 224 may exist within a provider network 240, which may be separate from the network that smart device or hardware button 204 is using. Thus, a session border controller (SBC) 230-1 may use SIP to communicate with an SBC 230-2 of provider network 240. This ensures that data are correctly shared between the two networks. GMLC 216 can thus provide the appropriate information to PSAP 224, which can route the call to the appropriate location, connect the caller with an emergency operator, and dispatch appropriate emergency services.

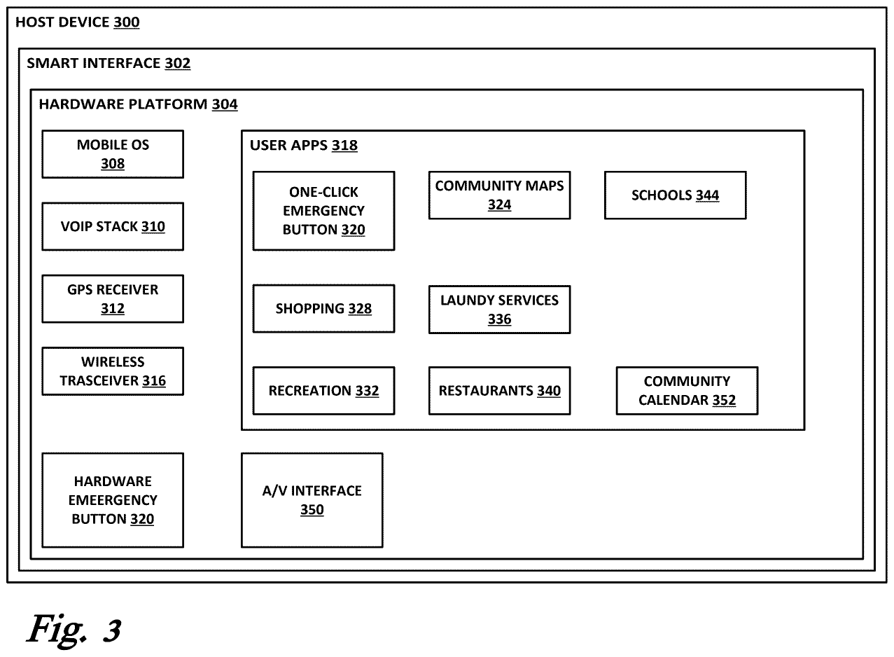

FIG. 3 is a block diagram of selected elements of a host device 300, which may host an emergency call button. As described above, this may be a hardware button, or an easily accessible software button.

Host device 300 includes a smart interface 302, which may be for example a tablet computer, a cellular phone, or an analog button architecture with audio input and output devices.

A hardware platform 304 provides the necessary hardware for providing the communication. This may include for example a mobile operating system 308, which may be any suitable mobile operating system such as Apple iOS, mobile Linux, mobile Windows, mobile Unix, or a custom operating system, or other.

A voice over internet protocol (VOIP) stack 310 provides voice services, which allows an operator of host device 302 to speak to an operator over the IP network.

A GPS receiver 312 receives high-resolution GPS location data from a GPS satellite. A wireless transceiver 316 provides wireless communication with a network such as 2G, 3G, 4G, 5G, 6G, or other networks. A wireless transceiver is used here as an illustrative embodiment, and in some cases such as a kiosk or base station, wired infrastructure could also be provided.

In this example a hardware emergency button 320 may provide a highly intuitive interface to allow a person to immediately place an emergency call. Alternatively, within user apps 318, a one-click emergency button 320 could also provide a highly intuitive software interface for placing an emergency call.

User apps 318 may also include other apps related to the function of host device 300. For example, in a golf cart community user apps 318 may include shopping information 328, recreational information 332, community maps 324, laundry services 336, restaurants 340, school 344, and a community calendar 352. These apps may be valuable for providing information that a resident of or visitor to the community may need in navigating the community. For example, if the user is riding writing the golf cart, he may want to find the nearest restaurants, and so can click on the restaurants button and see a map of nearby restaurants with cuisine, reviews, and other information such as hours and prices. If the user selects a particular restaurant, then the GPS function can help the user navigate to that restaurant.

Hardware platform 304 may also include an audio/video interface 350. AV interface 350 may enable the user to contact emergency services and speak to an emergency operator, even in cases where he is not carrying his cell phone. Alternatively, if the user is carrying a cell phone, then host device 300 may route the 911 call through his device, which he can register with host device 300. This can enable the emergency call to go through the user's own cell phone without him having to dial 911 or determine his exact location on his own.

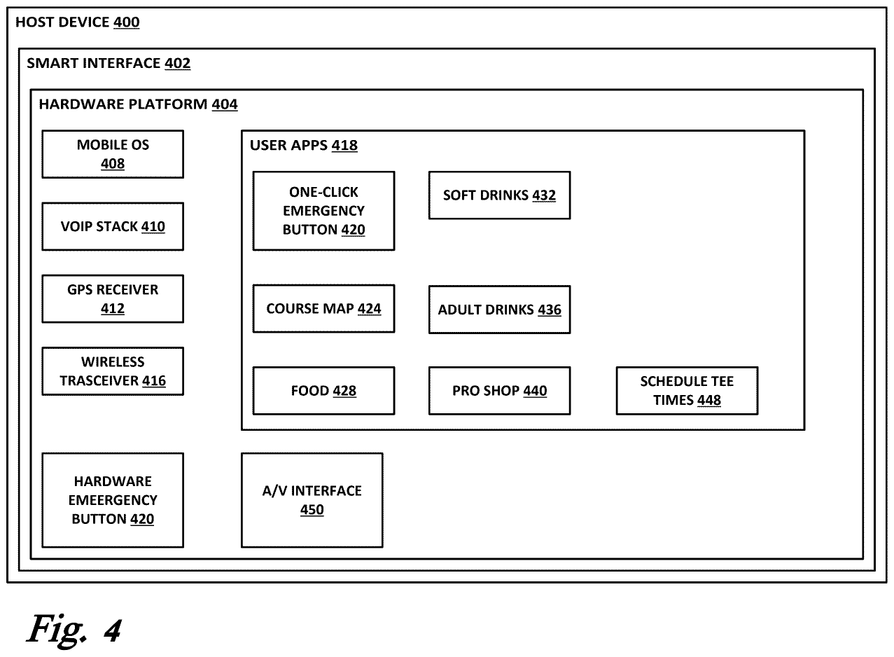

FIG. 4 is a block diagram of another embodiment of a host device 400. Selected elements are shown here to illustrate a device that might be found on a golf cart for a golf club.

In this example host device 400 includes a smart interface 402, which may be for example a tablet computer affixed to the golf cart.

Similar to host device 300, a hardware platform 404 provides the processor, memory, and other hardware elements. A mobile operating system 408, VOIP stack 410, GPS receiver 412, and wireless transceiver 416 may be analogized to elements 308, 310, 312, and 316 of FIG. 3 respectively.

A hardware emergency button 420 may be provided, such as a red or orange button with appropriate markings to enable fast and effortless calling to an emergency service.

User apps 418 may be different from the applications provided in user apps 318 of FIG. 3. These applications may be tailored to the golf experience, such as a course map 424, an interface to order food 428, an interface to order soft drinks 432 or adult drinks 436, and an interface to Pro shop 440. In some high-end golf clubs, customers are able to order goods or services on the course, and those goods are ready for them at the clubhouse when they return. In other cases, users can order food, drinks, or equipment (such as extra balls) which can be delivered to them on the course. User apps 418 may also include an interface to schedule tee times 448. As in FIG. 3, a one-click emergency software button 420 may be provided, and may be easily accessible or always on to provide straightforward emergency calling services.

In some embodiments, an audio and/or video interface 450 may be provided. A/V interface 450 may receive spoken audio, play audio, and provide two-way video communication. For example, A/V interface 450 may enable a video call between the user and a PSAP or other emergency responder. This may provide useful context, such as a video feed that can help first responders identify an exact location for the caller. In some cases, audio may also be transcribed in real-time and sent to the PSAP as a real-time transcript of the conversation.

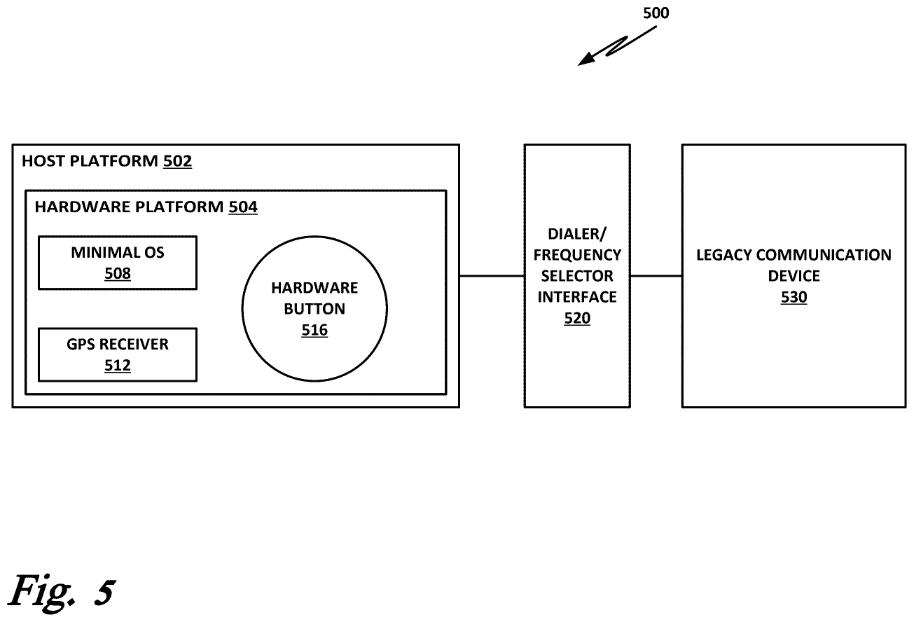

FIG. 5 is a block diagram of a communication interface 500. The ecosystem of FIG. 5 may enable the integration of the systems and methods taught herein with a legacy communication device 530. Legacy communication device 530 may be a cell phone, tablet, smartphone, or other communication device. In some embodiments, legacy communication device 530 may lack GPS capabilities, or maybe a previous generation device with only low-resolution location services.

A host platform 502 includes a hardware platform 504, which provides a simple button for emergency calling. This may be a hardware button 516 as illustrated, although a software button is also possible. In this example, the system may include a minimal operating system 508, and a GPS receiver 512. This architecture may be built, for example, to provide a kiosk, emergency call station, or other similar facility. Host platform 502 may interoperate with legacy communication device 530 with a dialer or frequency selector interface 520.

For example, in the case where legacy communication 530 is a cell phone or satellite phone, when a user operates hardware button 516, host platform 502 may use dialer interface 520 to place a call via legacy communication device 530. This may include causing legacy communication device 530 to dial 911 or other appropriate emergency services.

In the case where legacy communication device 530 is a radio, host platform 502 may operate frequency selector 520 to select an appropriate frequency and/or encryption method and/or encoding method to contact emergency response services. This may be useful in the context, for example, of firefighting, law enforcement, or military service.

In this example, it is illustrated that host platform 502 need not necessarily replace legacy communication device 530, but rather may work together with legacy communication device 530 to place an emergency call to the appropriate emergency response services. Conceptually, it may be possible for a human operator in at least some cases to directly operate legacy communication device 530 to place the emergency call. For example, a ship at sea may be able to include a radio or satellite phone that the operator can directly manipulate to place an emergency or SOS call. However, legacy communication device 530 may not have the benefit of a GPS receiver, and in a high-stress situation, human operation may be error-prone. It may thus be simpler for the human operator to simply press hardware button 516 to immediately place the emergency call without having to think about operating the dialer or selecting appropriate frequencies or encodings. The emergency call may be placed immediately, and the GPS data may be appropriately encoded over the communication channel. For example, in a cellular network with a data plane, the GPS coordinates may be sent via that data plane. In the case of a radio, the GPS coordinates may be encoded for example using a tone encoding or other data transmission techniques available on amateur or broadcast radios. For example, new packet radio (NPR) and Winlink are two known methods of transmitting digital data over amateur radio. Other data encodings, including encrypted or unencrypted encodings, may be used.

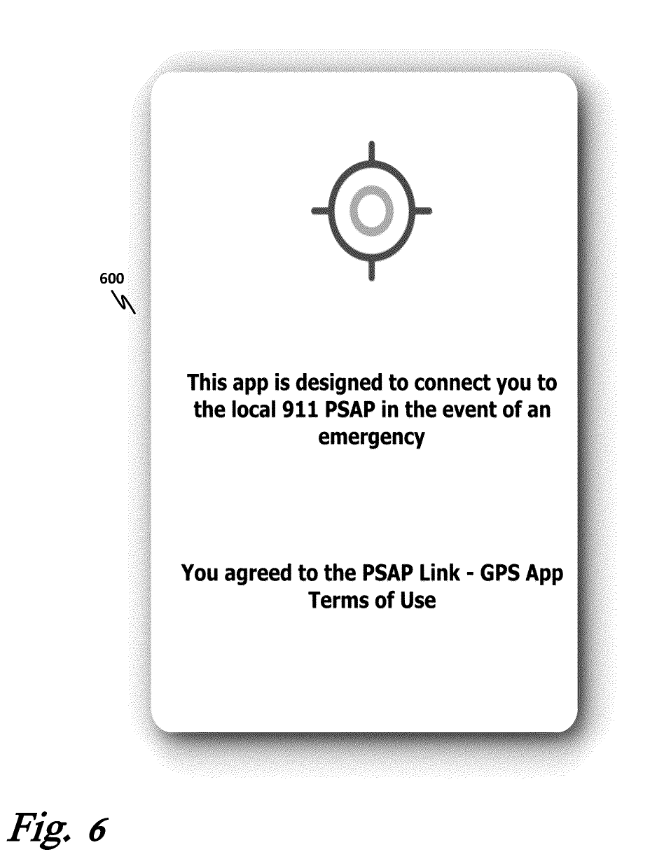

FIG. 6 is an example of a user interface element that may be seen on a smart interface. UI element 600 includes initial information and a set-up screen, which indicates that the app is designed to connect the user to a PSAP in the case of an emergency. UI element 600 also gives the user an opportunity to accept the terms of service and privacy policy.

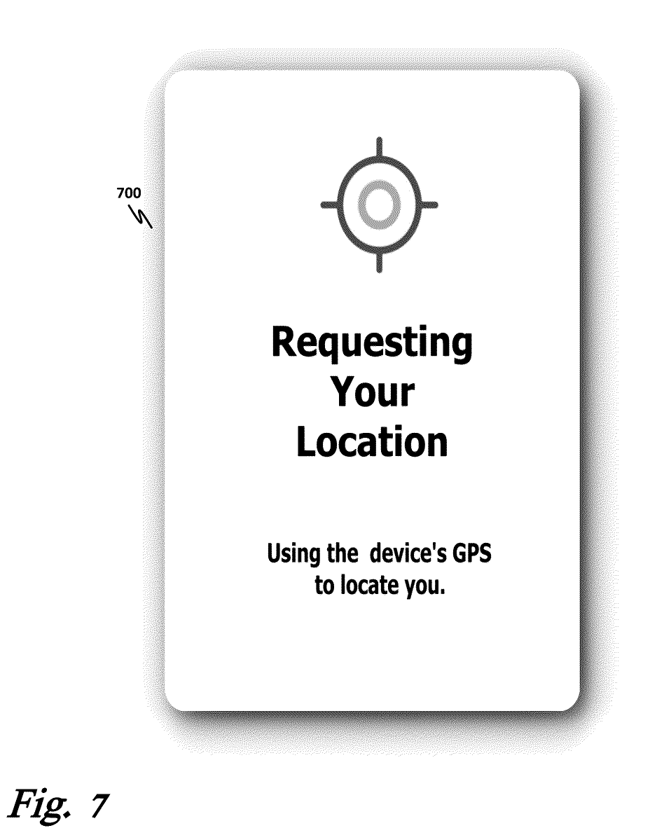

FIG. 7 is an illustration of a UI element 700, which shows a pending operation screen in which the user is informed that the device is fetching the user's current location. For example, the user may register her cell phone with the smart device, and the device may then connect to the cell phone using for example the cellular network, Bluetooth, or other communication protocols. The smart device may then use the user's cell phone to identify her GPS location. In this case, UI element 700 also notifies the user that she should place her phone in a position where has a clear view of the sky. This may enhance GPS reception.

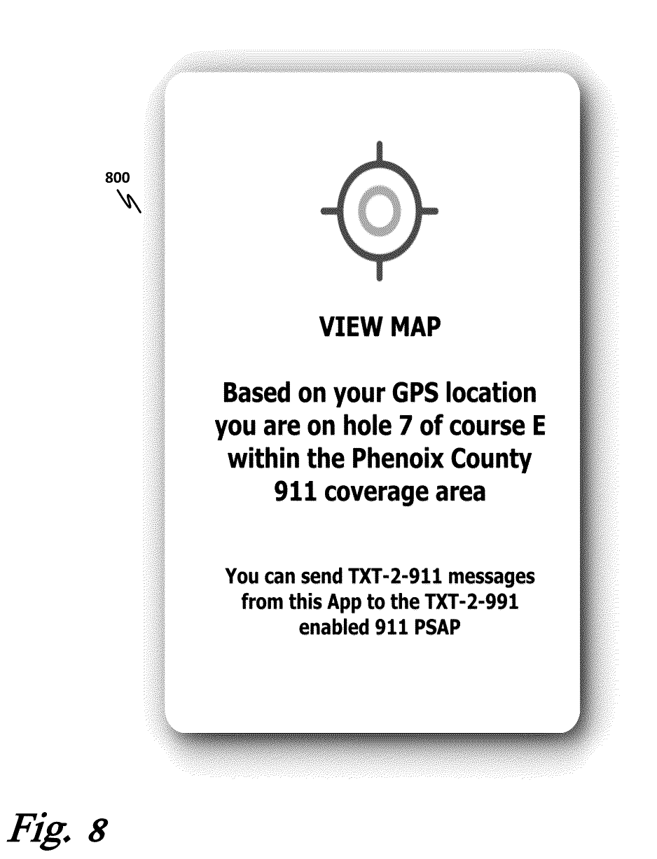

FIG. 8 is an illustration of UI element 800. This is an information screen, in which the user is informed that her cell phone has connected and the device has determined her GPS coordinates. She is currently on hole seven of golf course E, within the Phoenix County 911 coverage area. The interface also informs the user that the Phoenix County 911 PSAP specifically monitors for text to 911 messages sent from the PSAP link. This may be valuable in cases where connectivity is limited, and where audio and/or video communication is more difficult. In that case, the PSAP link may send a 911 text message with an emergency notification and with the GPS coordinates. This may provide less information than would be available by directly speaking with the user, but may provide enough information to dispatch emergency services to tend to an emergency.

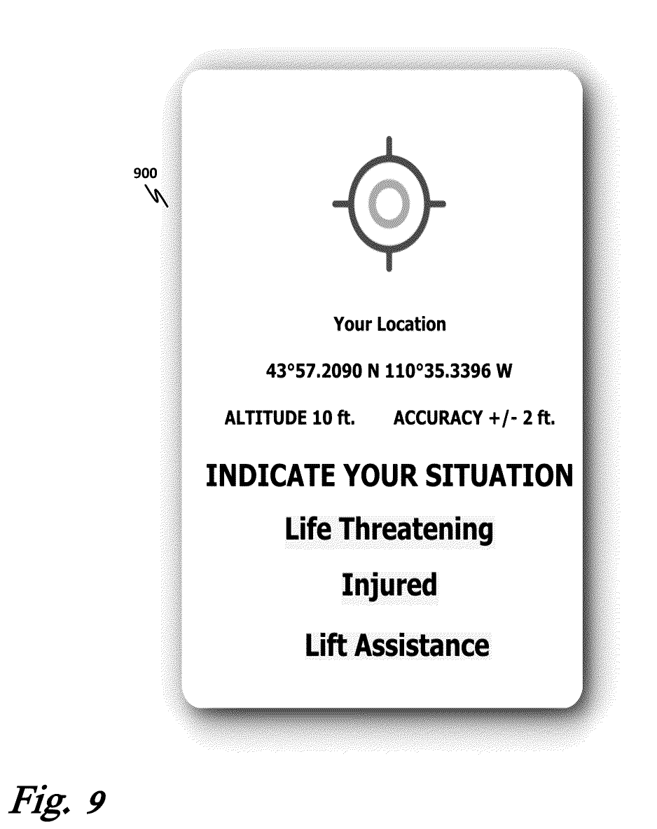

FIG. 9 illustrates a UI element 900. In this case, a software button is used to provide a 911 call. In the case of limited connectivity, or other cases where it may be desirable to use an SMS or text interface, the user has the option to provide some basic information about the situation. For example, when the user presses the emergency button, she can indicate the type of emergency she is experiencing. In this case, she may indicate that the emergency is life-threatening. Furthermore, the smart interface displays her current location with an accuracy of approximately plus or minus 20 feet, which should be sufficient for first responders to find her and provide assistance.

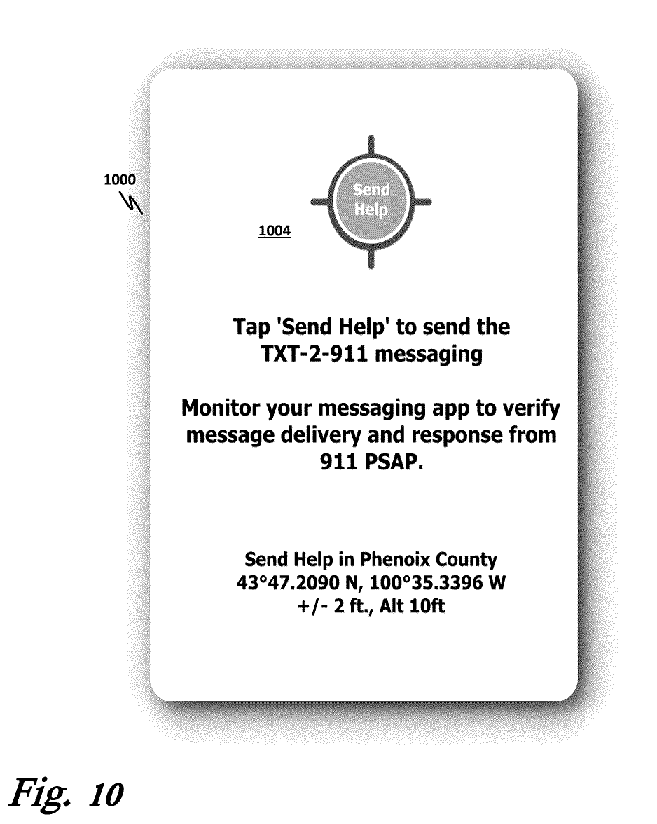

FIG. 10 is a block diagram of a UI element 1000. In this case, a send help SOS button 1004 is provided. The user may tap send help button SOS 1004 to launch her text messaging application on her phone. The text messaging application may be preloaded with the recipient and with the message that includes her location, and the nature of the emergency. She can then send the text message simply by clicking the send button on her phone.

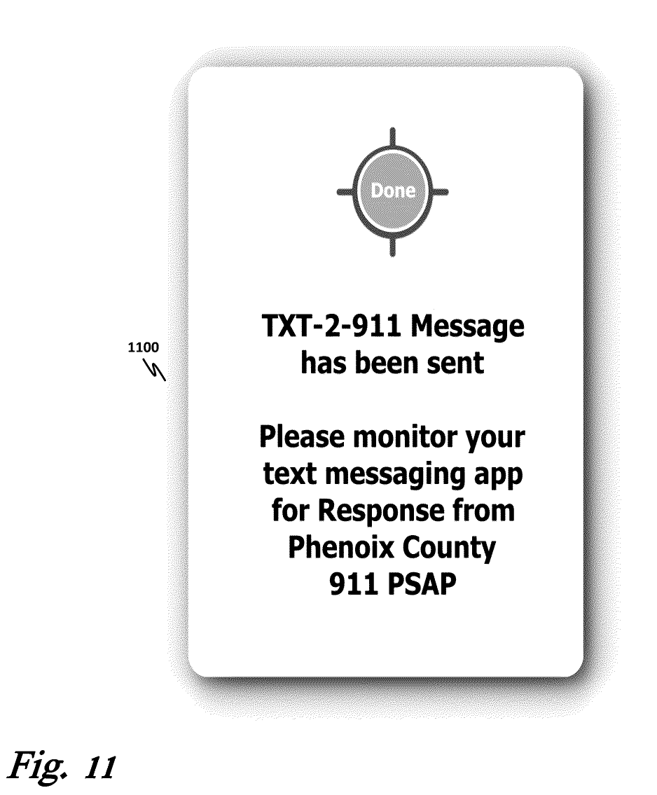

FIG. 11 is an illustration of a UI element 1100. This is an informational screen that indicates that the SMS message has been sent, and the user is notified that she should monitor her text messaging app to verify message delivery and to receive responses from the County 911 dispatch.

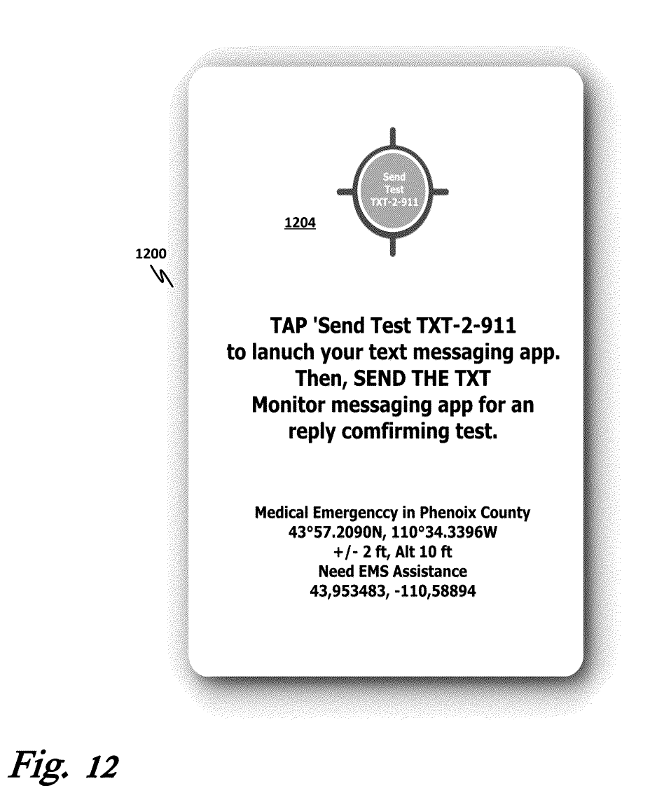

FIG. 12 is an illustration of a UI element 1200, which in this case is a test interface. This can help the user complete setup, and can ensure that the system is working correctly. In this case, a send test button 1204 is provided, which will launch the user's messaging app similar to the send help button 1004 of FIG. 10. In this case, rather than routing the message to the 911 dispatch center, the message may instead be sent to a dummy service that will discard the message. This can be used to train the user on the operation of the smart interface, and to give her confidence that the system is working correctly. After she sends the test message, she may understand how the system works, and be prepared to use the send help button 1004 (FIG. 10) if necessary.

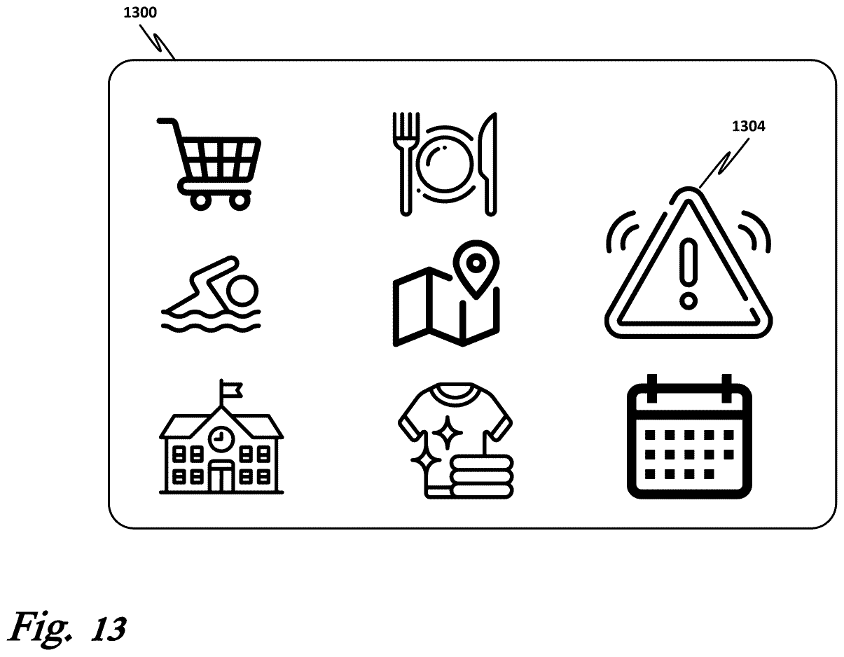

FIG. 13 is an illustration of a user interface 1300, which may be provided on a smart device. UI 1300 may be provided for a golf cart-based community, in which smart tablets are provided on the golf cart to aid in navigation around the community. Icons are provided for various services such as shopping, recreation, schools, dining, community maps, laundry, and a community calendar.

Also provided here is a prominent emergency button 1304, which in this case is a software button. When the user presses the emergency button, then appropriate emergency messages may be sent either via built-in communications on the golf cart itself, or via the user's cell phone which has been connected to the app via Bluetooth or other means. In response to the user operating the emergency button 1304, in some cases a confirmation screen may be provided to ensure that the user is genuinely trying to place an emergency call. This may help to prevent false positives or accidental presses. However, there is some balance between preventing false positives and adding additional steps when an emergency occurs. Those having skill in the art may select whether and how much verification to provide in case emergency button 1304 is operated. Once the user has operated the button and optionally provided verification, then appropriate messages may be dispatched to the PSAP, which may include placing the user in audio and/or video communication with the PSAP, sending a text message, or providing other emergency notifications.

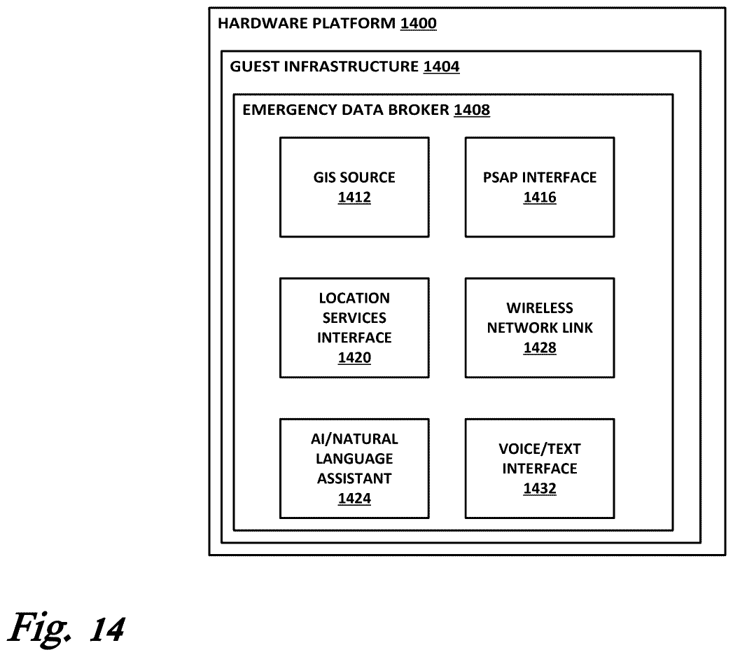

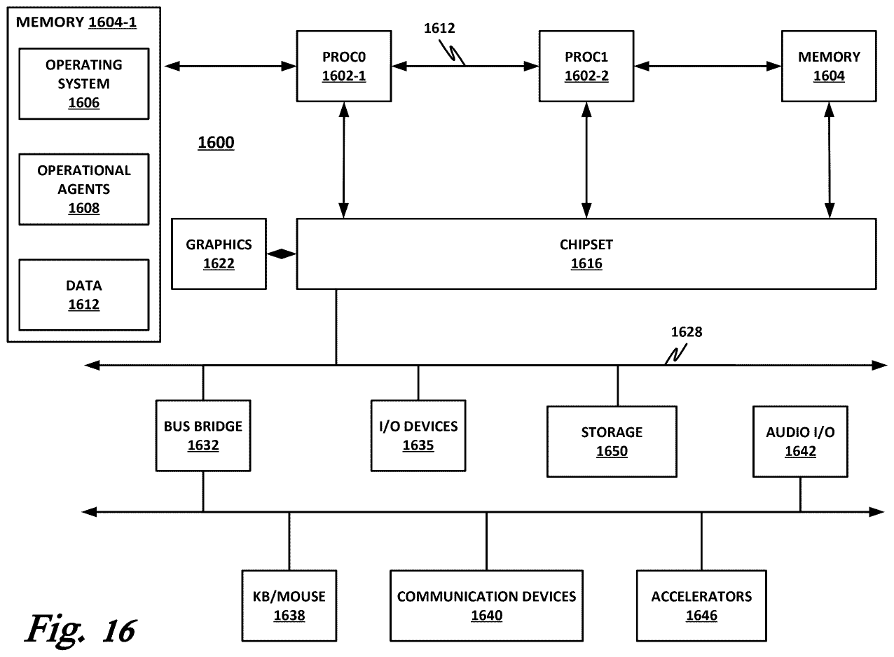

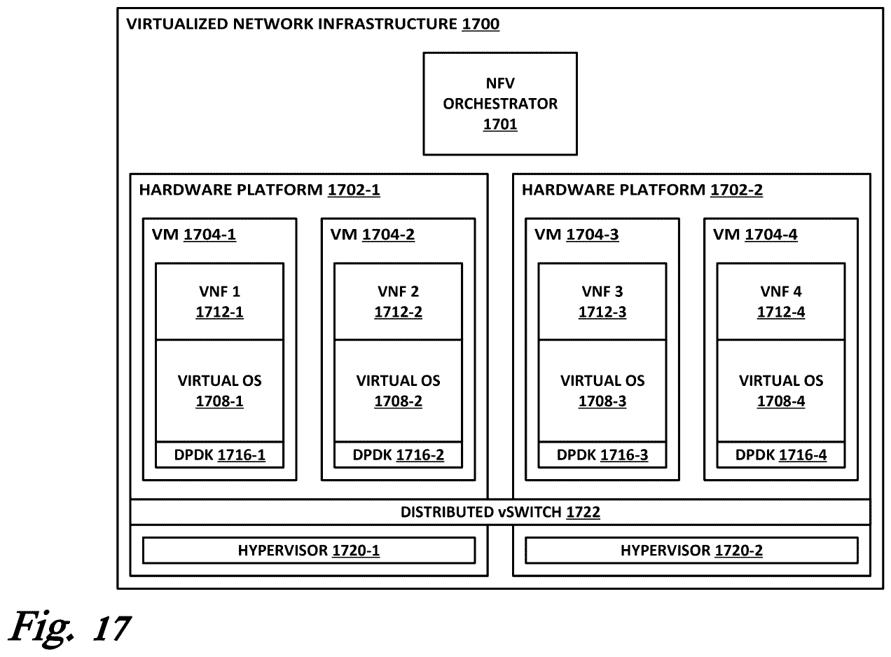

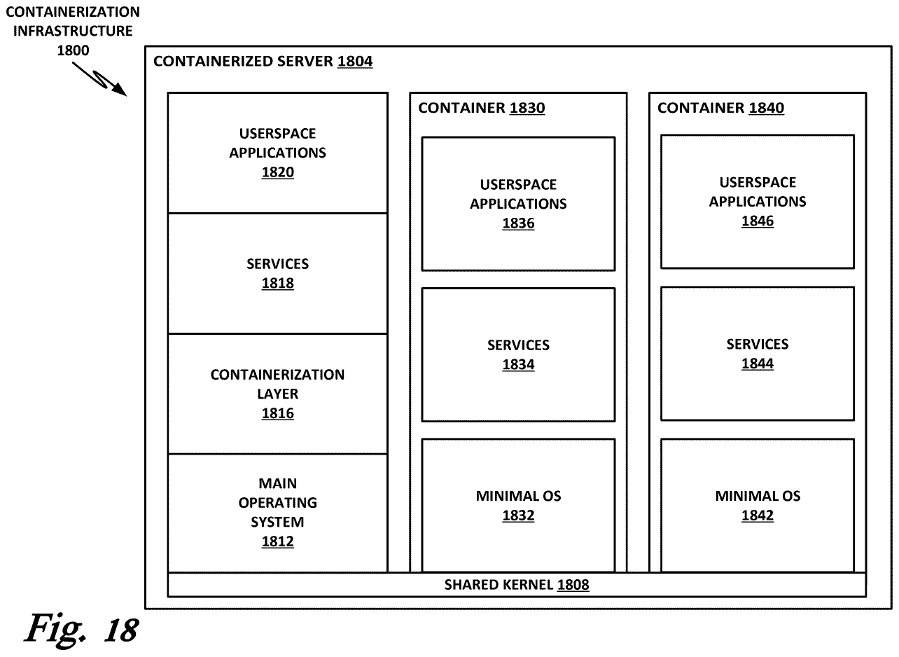

FIG. 14 is a block diagram of a hardware platform 1400. Hardware platform 1400 in this example provides a platform for an emergency data broker 1408, which may be an example of an emergency data broker 124 (FIG. 1), or a different embodiment of an emergency data broker. In this example, emergency data broker 1408 operates on a guest infrastructure 1404, which may, be for example, a virtualization infrastructure as illustrated in FIG. 17, or a containerization infrastructure as illustrated in FIG. 18. An example of elements that may be present in a hardware platform artless traded in FIG. 16.

Emergency data broker 1408 may provide intermediary services that may not be native to existing wireless communication or telephoning infrastructure. Thus, emergency data broker 1408 may be particularly configured to provide brokered services as illustrated in this specification.

In this example, emergency data broker 1408 includes a wireless network link 1428, which may communicatively couple emergency data broker 1408 to a wireless or wired telephoning network (e.g., a 4G LTE and/or 5G NR network), or other networks including wired networks like “plain old telephone service” (POTS). Link 1428 may provide a connection to an emergency notification device such as those devices illustrated throughout the specification. Wireless network link 1428 may also connect emergency data broker 1408 to a wireless network as illustrated in FIG. 2. This connection may enable emergency data broker 1408 to communicatively couple an emergency device to first responders such as a PSAP.

Emergency data broker 1408 may receive an emergency communication, for example via wireless network 1428. The emergency communication may include a payload that provides a specific GPS location, which may be a three dimensional GPS location for some emergency devices. Emergency data broker 1408 may use location services interface 1420 to determine a location of the emergency device, which may include traditional location services on the wireless network. These data may be supplemented with the specific GPS location as provided by the device. Even in the case where the device provides an exact GPS location, correlating with traditional location services may help to increase confidence in the provided location.

Emergency data broker 1408 may use GIS source 1412 to correlate the provided location with GIS data. GIS source 1412 may be a traditional global GIS database, with information about worldwide locations. However, in some examples, GIS source 1412 need not be restricted to globally-available data, but may include an aggregation of various local information sources. For example, emergency data broker 1408 may have local data about communities, recreational facilities, high-rise buildings, campuses, parks, or other locations that are relevant to the service area of the emergency data broker.

A voice and text interface 1432 may permit communication with both the user who is calling for emergency services, and with the PSAP. A PSAP interface 1416 may communicatively couple emergency data broker 1408 to the legacy PSAP infrastructure, and provides connectivity into existing emergency services.

In some cases, it may be desirable to provide human readable or plain text descriptions of locations, a digest of an emergency message, a transcription of a spoken emergency message, or other language services. In that case, emergency data broker 1408 may also include an artificial intelligence and/or natural language assistant module 1424. This module may summarize spoken or written text, transcribe text, or provide a human-readable narrative description of a particular location. In some cases, the description may be provided both to the PSAP and back to the caller. This may ensure that both the emergency first responders and the caller have a good understanding of the caller's location.

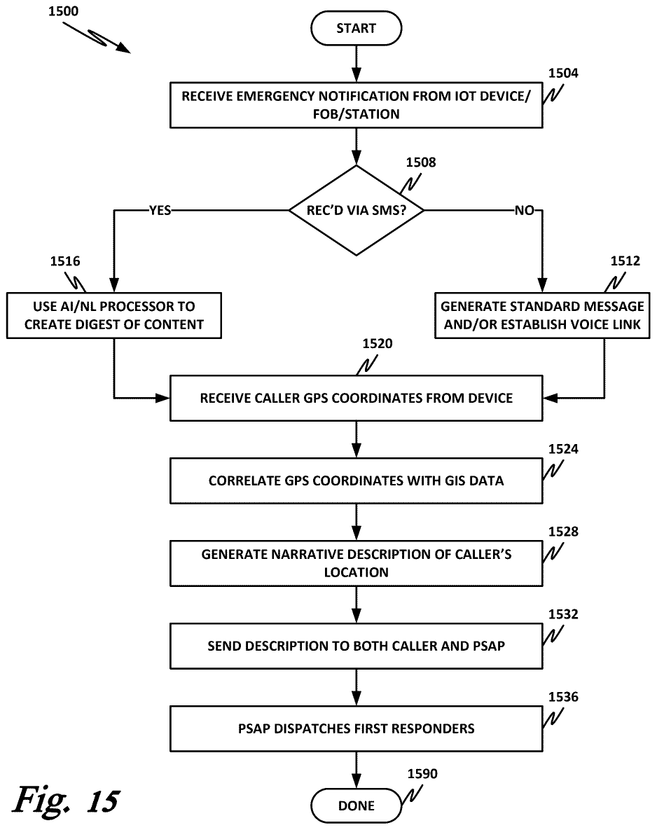

FIG. 15 is a flowchart of a method 1500 of providing emergency services, for example within an emergency data broker.

At block 1504, the system receives an emergency notification from an IoT device, a fob, a dongle, a base station, a kiosk, or another remote device.

In block 1508, the system determines whether the message was received via SMS. In some cases, the device may automatically provide SMS messages as illustrated, for example, in FIG. 10. Processing of an SMS message may be different from processing of a voice message.

If this is a voice message, then in block 1516 the system may use an AI or NL processor to create a digest of the content, to summarize the location, or to provide other useful information.

If this is not a text message, then in block 1512 the system may generate a standard notification to be forwarded to the PSAP.

In block 1520, the system may receive the caller's GPS coordinates from the remote device.

In block 1524, the system may query a global or local GIS database to correlate the GPS coordinates with relevant GIS data. As discussed above, this may include more detailed information for local sites of interest.

In block 1528, the system may use an NL assistant to generate a narrative description of the caller's location.

In block 1532, the system may send the description both to the caller and to the PSAP. This ensures that both the caller and the PSAP have a good narrative description of the location, and that they both have the same description.

In block 1536, the PSAP dispatches first responders to assist the caller.

In block 1590, the method is done.

FIG. 16 is a block diagram of a hardware platform 1600. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 1600, even though they may be scattered across a data center, or even located in different data centers.

Hardware platform 1600 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 1600 is arranged in a point-to-point (PtP) configuration. This PtP configuration is popular for personal computer (PC) and server-type devices, although it is not so limited, and any other bus type may be used.

Hardware platform 1600 is an example of a platform that may be used to implement embodiments of the teachings of this specification. For example, instructions could be stored in storage 1650. Instructions could also be transmitted to the hardware platform in an ethereal form, such as via a network interface, or retrieved from another source via any suitable interconnect. Once received (from any source), the instructions may be loaded into memory 1604, and may then be executed by one or more processor 1602 to provide elements such as an operating system 1606, operational agents 1608, or data 1612.

Hardware platform 1600 may include several processors 1602. For simplicity and clarity, only processors PROC0 1602-1 and PROC1 1602-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 1602 may be any type of processor and may communicatively couple to chipset 1616 via, for example, PtP interfaces. Chipset 1616 may also exchange data with other elements, such as a high performance graphics adapter 1622. In alternative embodiments, any or all of the PtP links illustrated in FIG. 16 could be implemented as any type of bus, or other configuration rather than a PtP link. In various embodiments, chipset 1616 may reside on the same die or package as a processor 1602 or on one or more different dies or packages. Each chipset may support any suitable number of processors 1602. A chipset 1616 (which may be a chipset, uncore, Northbridge, Southbridge, or other suitable logic and circuitry) may also include one or more controllers to couple other components to one or more central processor units (CPU).

Two memories, 1604-1 and 1604-2 are shown, connected to PROC0 1602-1 and PROC1 1602-2, respectively. As an example, each processor is shown connected to its memory in a direct memory access (DMA) configuration, though other memory architectures are possible, including ones in which memory 1604 communicates with a processor 1602 via a bus. For example, some memories may be connected via a system bus, or in a data center, memory may be accessible in a remote DMA (RDMA) configuration.

Memory 1604 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1(L1) or Layer 2(L2) memory, on-chip memory, registers, virtual memory region, read-only memory (ROM), flash memory, removable media, tape drive, cloud storage, or any other suitable local or remote memory component or components. Memory 1604 may be used for short, medium, and/or long-term storage. Memory 1604 may store any suitable data or information utilized by platform logic. In some embodiments, memory 1604 may also comprise storage for instructions that may be executed by the cores of processors 1602 or other processing elements (e.g., logic resident on chipsets 1616) to provide functionality.

In certain embodiments, memory 1604 may comprise a relatively low-latency volatile main memory, while storage 1650 may comprise a relatively higher-latency nonvolatile memory. However, memory 1604 and storage 1650 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 1604 and storage 1650, for example, in a single physical memory device, and in other cases, memory 1604 and/or storage 1650 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 1622 may be configured to provide a human-readable visual output, such as a command-line interface (CLI) or graphical desktop such as Microsoft Windows, Apple OSX desktop, or a Unix/Linux X Window System-based desktop. Graphics adapter 1622 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 1622 may include a hardware graphics card, which may have its own memory and its own graphics processing unit (GPU).

Chipset 1616 may be in communication with a bus 1628 via an interface circuit. Bus 1628 may have one or more devices that communicate over it, such as a bus bridge 1632, I/O devices 1635, accelerators 1646, communication devices 1640, and a keyboard and/or mouse 1638, by way of nonlimiting example. In general terms, the elements of hardware platform 1600 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 1640 can broadly include any communication not covered by a network interface and the various I/O devices described herein. This may include, for example, various universal serial bus (USB), FireWire, Lightning, or other serial or parallel devices that provide communications.

I/O Devices 1635 may be configured to interface with any auxiliary device that connects to hardware platform 1600 but that is not necessarily a part of the core architecture of hardware platform 1600. A peripheral may be operable to provide extended functionality to hardware platform 1600, and may or may not be wholly dependent on hardware platform 1600. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 1642 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 1632 may be in communication with other devices such as a keyboard/mouse 1638 (or other input devices such as a touch screen, trackball, etc.), communication devices 1640 (such as modems, network interface devices, peripheral interfaces such as PCI or PCIe, or other types of communication devices that may communicate through a network), audio I/O 1642, a data storage device 1644, and/or accelerators 1646. In alternative embodiments, any portions of the bus architectures could be implemented with one or more PtP links.

Operating system 1606 may be, for example, Microsoft Windows, Linux, UNIX, Mac OS X, IOS, MS-DOS, or an embedded or real-time operating system (including embedded or real-time flavors of the foregoing). In some embodiments, a hardware platform 1600 may function as a host platform for one or more guest systems that invoke application (e.g., operational agents 1608).

Operational agents 1608 may include one or more computing engines that may include one or more nontransitory computer-readable mediums having stored thereon executable instructions operable to instruct a processor to provide operational functions. At an appropriate time, such as upon booting hardware platform 1600 or upon a command from operating system 1606 or a user or security administrator, a processor 1602 may retrieve a copy of the operational agent (or software portions thereof) from storage 1650 and load it into memory 1604. Processor 1602 may then iteratively execute the instructions of operational agents 1608 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 1600 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCOE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 1600 may be virtualized, in particular the processor(s) and memory. For example, a virtualized environment may run on OS 1606, or OS 1606 could be replaced with a hypervisor or virtual machine manager. In this configuration, a virtual machine running on hardware platform 1600 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 16 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments.

FIG. 17 is a block diagram of a NFV infrastructure 1700. NFV is an example of virtualization, and the virtualization infrastructure here can also be used to realize traditional VMs. Various functions described above may be realized as VMs, such as telecommunication services, PSAP services, location services, client/end-user functions, emergency data brokers, and PSAP links.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1700. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 17, an NFV orchestrator 1701 may manage several VNFs 1712 running on an NFVI 1700. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1701 a valuable system resource. Note that NFV orchestrator 1701 may provide a browser-based or graphical configuration interface, and in some embodiments may be integrated with SDN orchestration functions.

Note that NFV orchestrator 1701 itself may be virtualized (rather than a special-purpose hardware appliance). NFV orchestrator 1701 may be integrated within an existing SDN system, wherein an operations support system (OSS) manages the SDN. This may interact with cloud resource management systems (e.g., OpenStack) to provide NFV orchestration. An NFVI 1700 may include the hardware, software, and other infrastructure to enable VNFs to run. This may include a hardware platform 1702 on which one or more VMs 1704 may run. For example, hardware platform 1702-1 in this example runs VMs 1704-1 and 1704-2. Hardware platform 1702-2 runs VMs 1704-3 and 1704-4. Each hardware platform 1702 may include a respective hypervisor 1720, virtual machine manager (VMM), or similar function, which may include and run on a native (bare metal) operating system, which may be minimal so as to consume very few resources. For example, hardware platform 1702-1 has hypervisor 1720-1, and hardware platform 1702-2 has hypervisor 1720-2.

Hardware platforms 1702 may be or comprise a rack or several racks of blade or slot servers (including, e.g., processors, memory, and storage), one or more data centers, other hardware resources distributed across one or more geographic locations, hardware switches, or network interfaces. An NFVI 1700 may also include the software architecture that enables hypervisors to run and be managed by NFV orchestrator 1701.

Running on NFVI 1700 are VMs 1704, each of which in this example is a VNF providing a virtual service appliance. Each VM 1704 in this example includes an instance of the Data Plane Development Kit (DPDK) 1716, a virtual operating system 1708, and an application providing the VNF 1712. For example, VM 1704-1 has virtual OS 1708-1, DPDK 1716-1, and VNF 1712-1. VM 1704-2 has virtual OS 1708-2, DPDK 1716-2, and VNF 1712-2. VM 1704-3 has virtual OS 1708-3, DPDK 1716-3, and VNF 1712-3. VM 1704-4 has virtual OS 1708-4, DPDK 1716-4, and VNF 1712-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 17 shows that a number of VNFs 1704 have been provisioned and exist within NFVI 1700. This FIGURE does not necessarily illustrate any relationship between the VNFs and the larger network, or the packet flows that NFVI 1700 may employ.

The illustrated DPDK instances 1716 provide a set of highly-optimized libraries for communicating across a virtual switch (vSwitch) 1722. Like VMs 1704, vSwitch 1722 is provisioned and allocated by a hypervisor 1720. The hypervisor uses a network interface to connect the hardware platform to the data center fabric (e.g., a host fabric interface (HFI)). This HFI may be shared by all VMs 1704 running on a hardware platform 1702. Thus, a vSwitch may be allocated to switch traffic between VMs 1704. The vSwitch may be a pure software vSwitch (e.g., a shared memory vSwitch), which may be optimized so that data are not moved between memory locations, but rather, the data may stay in one place, and pointers may be passed between VMs 1704 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1722 is illustrated, wherein vSwitch 1722 is shared between two or more physical hardware platforms 1702.

FIG. 18 is a block diagram of selected elements of a containerization infrastructure 1800. Like virtualization, containerization is a popular form of providing a guest infrastructure. Various functions described herein may be containerized, such as telecommunication services, PSAP services, location services, client/end-user functions, emergency data brokers, and PSAP links.

Containerization infrastructure 1800 runs on a hardware platform such as containerized server 1804. Containerized server 1804 may provide processors, memory, one or more network interfaces, accelerators, and/or other hardware resources.

Running on containerized server 1804 is a shared kernel 1808. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1808 is main operating system 1812. Commonly, main operating system 1812 is a Unix or Linux-based operating system, although containerization infrastructure is also available for other types of systems, including Microsoft Windows systems and Macintosh systems. Running on top of main operating system 1812 is a containerization layer 1816. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1812 may also provide services 1818, which provide services and interprocess communication to userspace applications 1820.

Services 1818 and userspace applications 1820 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1812, they inherit the same file and resource access permissions as those provided by shared kernel 1808. For example, one popular application for containers is to run a plurality of web servers on the same physical hardware. The Docker daemon provides a shared socket, docker. sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker. sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1804, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1804).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors—especially type 1, or “bare metal,” hypervisors—provide such near-native performance that this advantage may not always be realized.

In this example, containerized server 1804 hosts two containers, namely container 1830 and container 1840.

Container 1830 may include a minimal operating system 1832 that runs on top of shared kernel 1808. Note that a minimal operating system is provided as an illustrative example, and is not mandatory. In fact, container 1830 may perform as full an operating system as is necessary or desirable. Minimal operating system 1832 is used here as an example simply to illustrate that in common practice, the minimal operating system necessary to support the function of the container (which in common practice, is a single or monolithic function) is provided.

On top of minimal operating system 1832, container 1830 may provide one or more services 1834. Finally, on top of services 1834, container 1830 may also provide userspace applications 1836, as necessary.

Container 1840 may include a minimal operating system 1842 that runs on top of shared kernel 1808. Note that a minimal operating system is provided as an illustrative example, and is not mandatory. In fact, container 1840 may perform as full an operating system as is necessary or desirable. Minimal operating system 1842 is used here as an example simply to illustrate that in common practice, the minimal operating system necessary to support the function of the container (which in common practice, is a single or monolithic function) is provided.

On top of minimal operating system 1842, container 1840 may provide one or more services 1844. Finally, on top of services 1844, container 1840 may also provide userspace applications 1846, as necessary.

Using containerization layer 1816, containerized server 1804 may run discrete containers, each one providing the minimal operating system and/or services necessary to provide a particular function. For example, containerized server 1804 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

The foregoing outlines features of several embodiments so that those skilled in the art may better understand various aspects of the present disclosure. The foregoing detailed description sets forth examples of apparatuses, methods, and systems relating to emergency connection services in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-82. (canceled)

83. A computer-implemented method of providing location-based emergency connection services, comprising:
receiving an emergency call from a remote device, the remote device having a one-click emergency call interface;
receiving a global positioning system (GPS) location for the remote device;
correlating the GPS location with global information system (GIS) data for the GPS location;
alerting a public safety answering point (PSAP), including providing the GPS location and GIS data; and
dispatching an emergency responder to the GPS location based on the GIS data.

84. The method of claim 83, wherein the GPS location is a three-dimensional location.

85. The method of claim 83, wherein the GIS data comprise three-dimensional location information for a multi-story building.

86. The method of claim 83, wherein the GIS data comprise local map data for a walkable or golf-cart community.

87. The method of claim 83, wherein GIS data comprise local intelligence for a golf course or recreational location.

88. The method of claim 83, wherein GIS data comprise local intelligence for a trail or outdoor recreational location.

89. The method of claim 83, wherein the remote device moves, and further comprising providing real-time location to the PSAP and/or the emergency responder.

90. The method of claim 83, wherein emergency call comprises a text message.

91. The method of claim 90, further comprising operating an artificial intelligence engine to provide a digest of the text message.

92. The method of claim 83, further comprising placing an operator of the remote device in verbal contact with the PSAP.

93. The method of claim 83, further comprising placing an operator of the remote device in verbal contact with the emergency responder.

94. The method of claim 83, further comprising providing back to an operator of the remote device a plain-text description of the GPS location.

95. The method of claim 83, wherein the remote device includes an autodialer to interface with a telephone or radio.

96. The method of claim 95, wherein the telephone or radio includes a 2G or 3G device that lacks native GPS capability.

97. One or more tangible, nontransitory computer-readable storage media having stored thereon executable instructions to:
receive, via a network interface, an emergency call from a remote device, the remote device having a one-click emergency call interface;
receive, via the network interface, a global positioning system (GPS) location for the remote device;
correlate the GPS location with global information system (GIS) data for the GPS location; and
send a message to notify an emergency responder of the emergency call, including the GPS location and the GIS data.

98. The one or more tangible, nontransitory computer-readable storage media of claim 97, wherein the GIS data comprise local map data for a walkable or golf-cart community.

99. A computing apparatus, comprising:
a hardware platform comprising a processor circuit and a memory;
a first network interface to communicatively couple to a remote device;
a second network interface to communicatively couple to an emergency response service; and
instructions encoded within the memory to instruct the processor circuit to:
receive, via the first network interface, an emergency call from the remote device;
receive, via the first network interface, a global positioning system (GPS) location for the remote device;
correlate the GPS location with global information system (GIS) data for the GPS location; and
send, via the second network interface, a message to notify the emergency response service of the emergency call, including the GPS location and the GIS data.

100. The computing apparatus of claim 99, wherein the remote device is a wearable fob, golf cart, non-street-legal vehicle, kiosk, ranger station, call box, single-sex space for women associated with a restaurant or bar, or military radio.

101. The computing apparatus of claim 99, further comprising a guest infrastructure to realize server functions.

102. The computing apparatus of claim 99, wherein the computing apparatus is realized as a telecommunication infrastructure service.
